(19) United States
(12) Patent Application Publication
(10) Pub. No.: US 2009/0243535 A1
(43) Pub. Date: Oct. 1, 2009

(54) Multi-Input Relay Board

(75) Inventors: William A. Erdmann, Largo, FL (US); Cornelius Hamilton, Wesley Chapel, FL (US); Donna Borgman, Seminole, FL (US); Leslie A. Fry, Largo, FL (US)

Correspondence Address: Johnson Controls, Inc.;c/o Fletcher Yoder PC, P.O. Box 692289, Houston, TX, 77269, US

(73) Assignee: Johnson Controls Technology Company, Holland, MI (US)

(21) Appl. No.: 12/059,565

(22) Filed: Mar. 31, 2008

(51) Int. Cl. H02P 3/18

(52) U.S. Cl. 318/813

(57) ABSTRACT

Fan relay boards are provided that include terminals configured to receive line power of approximately 115 volts, 208 volts, 230 volts, and 277 volts. The boards are configured to convert the line power to an approximately 24 volt output that is applied to a distribution circuit to select a high, medium, or low fan speed using relays. The boards may be coupled to a control device that designates the fan speed selected by the relays. The boards also may provide an approximately 24 volt power supply to external devices such as electric heaters, valves, and switches.

### BACKGROUND

The invention relates generally to multi-input fan relay boards.

Fans within heating, ventilation, air conditioning, and refrigeration (HVAC&R) systems typically draw air across a heat exchanger that heats or cools the air. The fan then directs the heated or cooled air to an environment through a system of vents and/or ductwork. Fans may be contained within air handling units that circulate and condition air for an entire building. Fans also may be contained within smaller terminal units that circulate air to an environment within a building. For example, fans may be contained within fan coil units or variable air volume units that provide conditioned air to individual apartments or offices. Various circuitry may be used for controlling such fans, and this circuitry often includes an electrical relay that switches the fan on or off depending upon a control signal from the HVAC&R system. In some applications, the relays are disposed on a circuit board or other support, and hard wired to other components.

In general, fan relays are coupled to a motor that drives a fan. The fan relay board receives power from a power supply, such as line power from the electrical grid, and provides power to the motor. The fan relay may also control the speed of the motor, thereby controlling the speed of the fan. For example, the fan relay may receive a speed command from a control device, such as a closed loop temperature controller, and provide appropriate electrical signals to the motor to operate the fan at the designated speed. Typically, the power used to drive the motor is converted by components, such as transformers, and used to control the speed of the motor. The power supply available may depend on the location of the HVAC&R system. For example, the supply power may be single-phase 115 volt power or 208 volt power entering a residential building. In commercial applications, the supply power may be single-phase 277 volt power used for building lighting. In general, however, specific circuitry (e.g., transformer) is provided for each rated power supply, requiring separate and specific wiring for the fan drive components, including the control relay. Not only does this require many different parts for manufacturing and service inventories, but the wiring itself is time-consuming and makes troubleshooting of later system problems tedious and difficult.

### SUMMARY

The present invention relates to a heating, ventilating, air conditioning, or refrigeration fan power supply device that includes a transformer configured to convert an approximately 277 volt input to an approximately 24 volt output. The transformer also is configured to convert at least one of an approximately 230 volt input, an approximately 208 volt input, and an approximately 115 volt input to the approximately 24 volt output. The device further includes a distribution circuit configured to receive the output and to provide power to a motor electrically coupled to one of the inputs.

The present invention also relates to a multi-tap transformer for controlling a speed of a fan for a heating, ventilating, air conditioning, or refrigeration system. The transformer includes a first tap configured to receive an approximately 277 volt power supply, a second tap configured to receive an approximately 230 volt power supply, a third tap configured to receive an approximately 208 volt power supply, a fourth tap configured to receive an approximately 115 volt power supply; and an output configured to provide an approximately 24 volt power supply to a distribution circuit that selects a designated speed for a fan motor powered by one of the 277 volt power supply, the 230 volt power supply, the 208 volt power supply, and the 115 volt power supply.

The present invention further relates to systems and methods employing the transformers and devices.

### DRAWINGS

FIG. 1 is a perspective view of an exemplary embodiment of a commercial or industrial HVAC&R system that employs terminal units.

FIG. 2 is an illustrated view of an exemplary embodiment of an air handler that may employ a fan relay board.

FIG. 3 is a perspective view of the air handler of FIG. 2 with a portion of the enclosure removed to show the interior components.

FIG. 4 is a block diagram of an exemplary embodiment of an HVAC&R system that employs a fan relay board.

FIG. 5 is an electrical schematic of an exemplary embodiment of a fan relay board.

### DETAILED DESCRIPTION

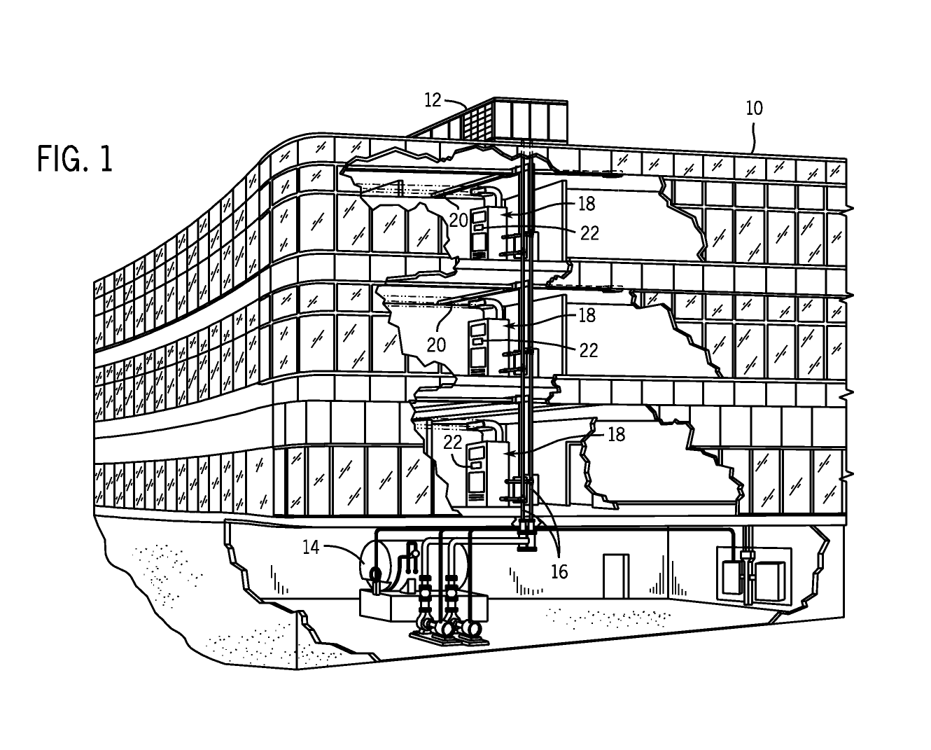

FIG. 1 illustrates an exemplary application, in this case an HVAC&R system for building environmental management that may employ fan relay boards. A building 10 is cooled by a system that includes a chiller 12 and a boiler 14. As shown, chiller 12 is disposed on the roof of building 10 and boiler 14 is located in the basement; however, the chiller and boiler may be located in other equipment rooms or areas next to the building. Chiller 12 is an air cooled or water cooled device that implements a refrigeration cycle to cool water. Chiller 12 may be a stand-alone unit or may be part of a single package unit containing other equipment, such as a blower and/or integrated air handler. Boiler 14 is a closed vessel that includes a furnace to heat water. The water from chiller 12 and boiler 14 is circulated through building 10 by water conduits 16. Water conduits 16 are routed to air handlers 18, shown here as fan coil units, located on individual floors and within sections of building 10. Air handlers 18 are also coupled to ductwork 20 that is adapted to distribute air between the air handlers and may receive air from an outside intake (not shown). Air handlers 18 include heat exchangers that circulate cold water from chiller 12 and hot water from boiler 14 to provide heated or cooled air. Fans, within air handlers 18, draw air through the heat exchangers and direct the conditioned air to environments within building 10, such as rooms, apartments or offices, to maintain the environments at a designated temperature. A control device 22, shown here as including a thermostat 22, may be used to designate the temperature of the conditioned air. Control device 22 also may be used to control the flow of air through and from air handlers 18. Other devices may, of course, be included in the system, such as control valves that regulate the flow of water and pressure and/or temperature transducers or switches that sense the temperatures and pressures of the water, the air, and so forth. Moreover, control devices may include computer systems that are integrated with or separate from other building control or monitoring systems, and even systems that are remote from the building.

Although the air handlers are shown here as fan coil units, in certain applications, the air handlers may be variable air volume units that receive cooled or heated air from a central air handling unit that includes a heat exchanger. In these applications, the central heat exchanger cools or heats the air and provides the conditioned air to a supply duct at a specified temperature. The fans within the variable air volume units control the flow of air from the supply duct, providing more or less air as needed to maintain the environment at the specified temperature, or in inhabited environments, at some desired level of comfort. Moreover, the air handlers are not limited to fan coil units or variable air volume units and may be other types of terminal or system units.

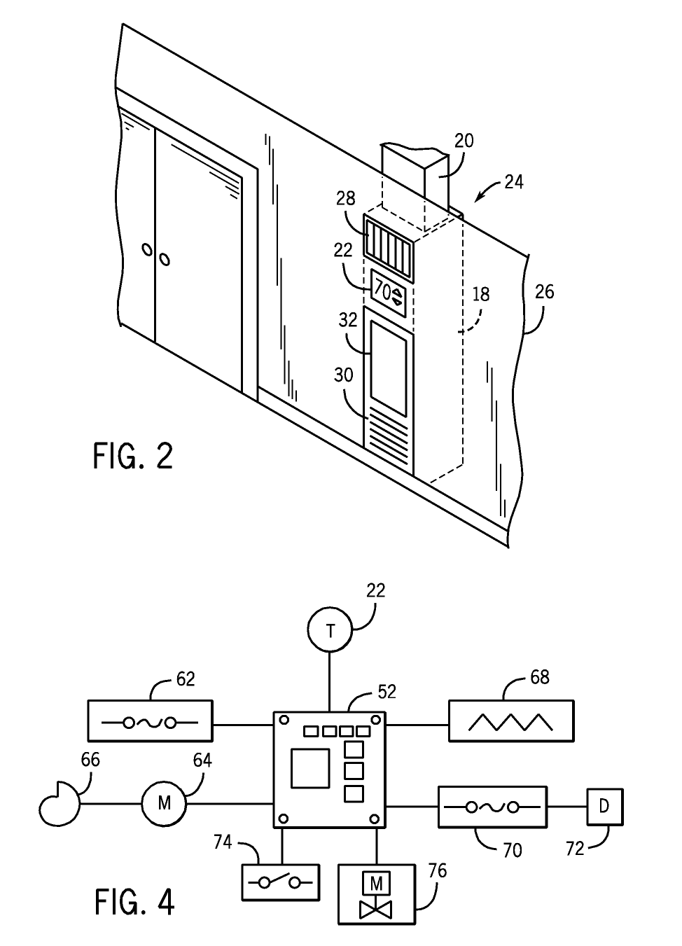

FIG. 2 illustrates an air handler 18, shown here as a fan coil unit, installed in the wall of an apartment or office. Air handler 18 is located in a mechanical space 24 and installed within an interior wall 26 of the building. Wall 26 separates mechanical space 24 from a conditioned environment that may be used for work or residential purposes. A grille 28, a vent 30, an access panel 32, and control device 22 are disposed within wall 26 and visible on the environment side of wall 26. The remaining portion of air handler 18, indicated generally by dashed lines, is located within mechanical space 24. Access panel 32 may be removed to provide access to air handler components, such as a filter and electrical wiring, contained within air handler 18. Ductwork 20 is connected to the top of air handler 18 and may route air to other air handlers located within the building.

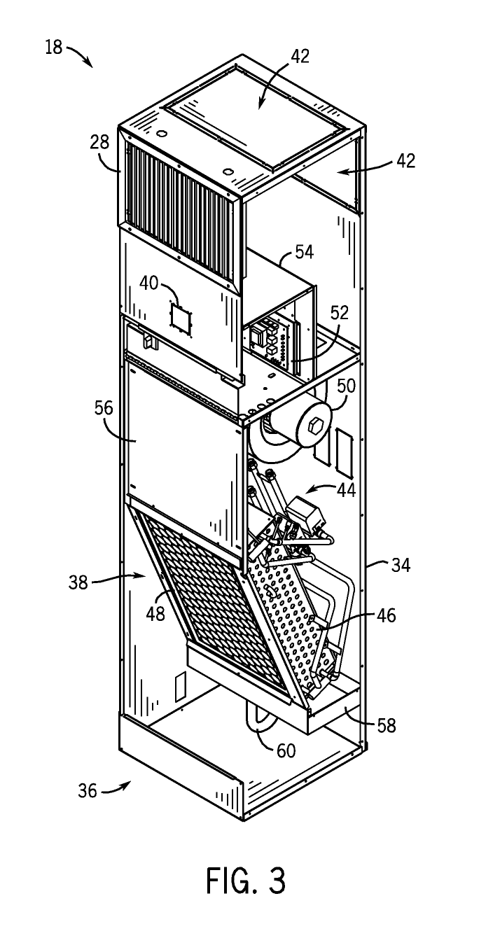

FIG. 3 is a detailed perspective view of the air handler shown in FIG. 2. Although the air handler may be any suitable air handler employing a fan relay board, according to a presently contemplated embodiment, the air handler may be an ENVIRO-TEC brand Vertical Hi-Rise direct drive fan coil unit commercially available from Johnson Controls, Inc. of Largo, Fla. Air handler 18 includes an enclosure 34 that houses, protects, and provides support for internal components. Although the enclosure may be constructed of any suitable material, according to an exemplary embodiment, the enclosure may be constructed of heavy gage galvanized steel lined with fiberglass insulation. Enclosure 34 includes a front surface 36 that may be disposed within an interior wall (see, for example, FIG. 2) such that grille 28 is located on the environment side of the interior wall and the remainder of the enclosure is located within a mechanical space. An opening 38 within enclosure 34 is accessible from the environment side and may be covered by an access panel (see FIG. 2, reference numeral 32). The access panel may be constructed of galvanealed steel or other suitable material and may contain a louvered vent (see FIG. 2, reference numeral 30) for returning air from the environment to air handler 18. A thermostat mount 40 is located on front surface 36 and provides a mount for a control device (such as an analog, digital display, or programmable thermostat) accessible from the environment. Grille 28 includes vented openings that allow conditioned air to flow into the environment. Enclosure 34 also includes openings 42 that may be used to connect ductwork (see FIG. 2, reference numeral 20) for directing air to a slave unit or another conditioned space.

A piping assembly 44 connects water conduits circulating cold and hot water to a heat exchanger or coil 46. Piping assembly 44 includes hoses, such as stainless steel braided hoses, for connecting coil 46 to the cold and hot water conduits. According to exemplary embodiments, the piping assembly 44 may contain hoses for a two-pipe system, providing one supply connection and one return connection for either hot or cold water, or a four-pipe system, providing a supply and return connection for hot water and a supply and return connection for cold water. Piping assembly 44 also may include one or more valves, such as 2-way or 3-way two position electric motorized valves and ball isolation valves, for regulating the flow of water within coil 46. According to exemplary embodiments, piping assembly 44 also may include other control devices such as floating point control valves, high pressure actuators, adjustable flow control devices, modulating control valves, and other suitable control mechanisms.

Coil 46 includes individual rows of heating and cooling coils, such as seamless copper tubes, that receive the hot and cold water circulating within the water conduits. Fins may be disposed between the coils to promote heat transfer between the water flowing within the heating and cooling coils and the air flowing through the heat exchanger and fins. A filter 48 is disposed on the air intake side of coil 46 and generally prevents contaminates, such as dust and debris, from contacting coil 46 and entering the conditioned air. According to exemplary embodiments, the filter may be a one-inch nominal glass fiber pleated filter accessible through opening 38.

A fan assembly 50 draws air over coil 46 to heat or cool the air. Air enters air handler 18 through a vent in opening 38 (see FIG. 2, reference numeral 30), passes through filter 48, and flows through coil 46 where the air is heated or cooled by water flowing within the coil. After exiting coil 46, the heated or cooled air is drawn up through air handler 18 and directed out grille 28 by fan assembly 50. Fan assembly 50 includes a fan and a motor that drives the fan. According to certain exemplary embodiments, the fan may be a double-width double-inlet centrifugal type, forward curved fan; however according to other exemplary embodiments, the fan may be any suitable fan for directing air within air handler 18. The motor powers the fan and controls the speed of the fan. The motor may be a direct drive or variable speed drive motor, such as a permanent split-capacitor motor or an electrically commutated motor. A blower shield 56 may be disposed in front of fan assembly 50 to prevent accidental contact with the fan and to prevent air from bypassing fan assembly 50.

A fan relay board 52 located within an electrical enclosure 54 is configured to control fan assembly 50. Fan relay board 52 may be electrically coupled to a power supply and electrically coupled to fan assembly 50. Fan relay board 54 also may be in electrical communication with control device 22 (FIG. 2) and various other control mechanisms such as valves contained within piping assembly 44.

Air handler 18 includes a drain pan 58 disposed beneath coil 46 to collect condensate that may collect on coil 46. The drain pan may be constructed of any material suitable for the collection of condensate. However, according to exemplary embodiments, the drain pan may be constructed of heavy gauge galvanized or stainless steel and positively sloped to direct condensate toward a P-trap 60 connected to a drain line (not shown). The drain line may run through the building in parallel with the water conduits. According to certain embodiments, P-trap 60 may include a float switch coupled to the fan relay board. The float switch may be configured to shut off fan assembly 50 if too much condensate has collected within drain pan 58.

It should be noted that the system and the air handler described above are exemplary applications for the control circuitry described below. That is, due to the many different environments in which such systems and air handlers may be used, a multi-standard control approach is made available by the circuitry described below. However, more generally, the circuitry may be applied to control fans on systems other than the chiller system described above, as well as in cooperation with components other than air handlers.

FIG. 4 is a simplified block diagram of an exemplary HVAC&R system that includes fan relay board 52. According to exemplary embodiments, fan relay board 52 may be a printed circuit board assembly that contains electronic components, such as a transformer, relays, terminals, signal conditioning circuitry and so forth, electrically connected by conductive pathways. Fan relay board 52 receives power from a power supply 62. Power supply 62 may be power supplied from a building alternating current (AC) electrical power supply. For example, power supply 62 may be tied to a building 115 volt single-phase electrical circuit that provides power to wall outlets, or power supply 62 may be tied to a building 208 volt circuit used to power building equipment. In another example where the building may employ a 277/480 volt system, power supply 62 maybe tied to a 277 volt single-phase lighting circuit. Power supply 62 may be three-phase or single-phase power. Moreover, power supply 62 may include single-phase power received from a three-phase distribution system by connecting the load between a phase and a neutral or by connecting the load between two phases. Power supply 62 also may include single-phase power received from a split phase (3-wire single-phase) distribution system. According to exemplary embodiments, the power supply may include standard voltages of 115 volts, 208 volts, 230 volts, and 277 volts received from a wye or delta connected system. The circuitry of the same board 52 is designed and configured to interface with any one of these electrical input standards.

Power supply 62 also may provide power to a motor 64 through fan relay board 52. Motor 64 drives a fan 66 that provides conditioned air to an environment. Motor 64 and fan 66 may be part of fan assembly 50, shown in FIG. 3. According to exemplary embodiments, the motor may be a permanent split-capacitor motor or an electrically commutated motor, and the fan may be centrifugal type forward curved fan. However, any suitable type fan and motor may be used. Motor 64 also may receive electrical signals from fan relay board 52 that determine the speed of the motor, or where desired, that simply turn the fan on and off.

Control device 22, in this case including a thermostat, provides signals to and receives signals from fan relay board 52. Control device 22 may be used to control the air temperature by designating a temperature set point and may be used to control the fan speed. According to certain exemplary embodiments, fan relay board 52 may use the temperature set point to vary the speed of motor 64. For example, if the temperature set point varies a relatively large amount from the ambient air temperature, the fan relay board may increase the fan speed. According to other certain embodiments, control device 22 may include a speed selector that designates the fan speed. For example, when the speed selector receives an input selecting a medium fan speed, the control device may provide a corresponding control signal to the fan relay board. The fan relay board may receive the control signal and in turn operate the fan at the medium speed, depending upon or independent of temperature.

Fan relay board 52 also may provide electrical energy to an electric heater 68. Electric heater 68 may receive electrical energy from board 52 and convert the energy into heat using a resistor or other suitable means. The electric heater may be included within the air handler and located behind the electrical enclosure, or the electric heater may be a stand-alone unit. The electric heater may function to provide additional heating capacity for an HVAC&R system.

Fan relay board 52 also may provide electrical energy to a power supply 70. Power supply 70 may be configured to receive electrical energy from board 52 and provide a low voltage power, such as a 24 volt AC waveform, to devices 72 employed by the HVAC&R system. For example, power supply 70 may power actuators or electric motor valves used to control the flow of water within the coil. Although external devices 72 may be powered by board 52, the external devices also may be powered by an independent power source not coupled to board 52.

Fan relay board 52 also may be connected to various control mechanisms, such as a float switch 74 and one or more valves 76. Float switch 74 may be configured to provide an automatic shut off when the condensate water level in drain pan 58 (shown in FIG. 3) exceeds a designated level. Float switch 74 may send a signal to fan relay board 52 when the designated level is exceeded to interrupt operation of motor 64 and fan 66. Valves 76 may be included in piping assembly 44 (shown in FIG. 3) and may be configured to control the flow of hot and cold water through the coil. For example, when hot air is required by the HVAC&R system, fan relay board 52 may send a signal to valve 76 to open the hot water valve and close the cold water supply valve. In another example, one of the valves may be a mixing valve that allows mixing of the hot and cold water to provide cooling to a designated temperature. According to exemplary embodiments, valves 76 may include position control valves with memory stops, two-way, two-position control valves, three-way, two-position control valves, two-way migrating control valves, three-way modulating control valves, and so forth. Although FIG. 4 shows board 52 connected to float switch 74 and valves 76, it should be noted that the board may be connected to any number and combination of control mechanisms including valves, actuators, flow regulators, pressure sensors, temperature sensors, and the like.

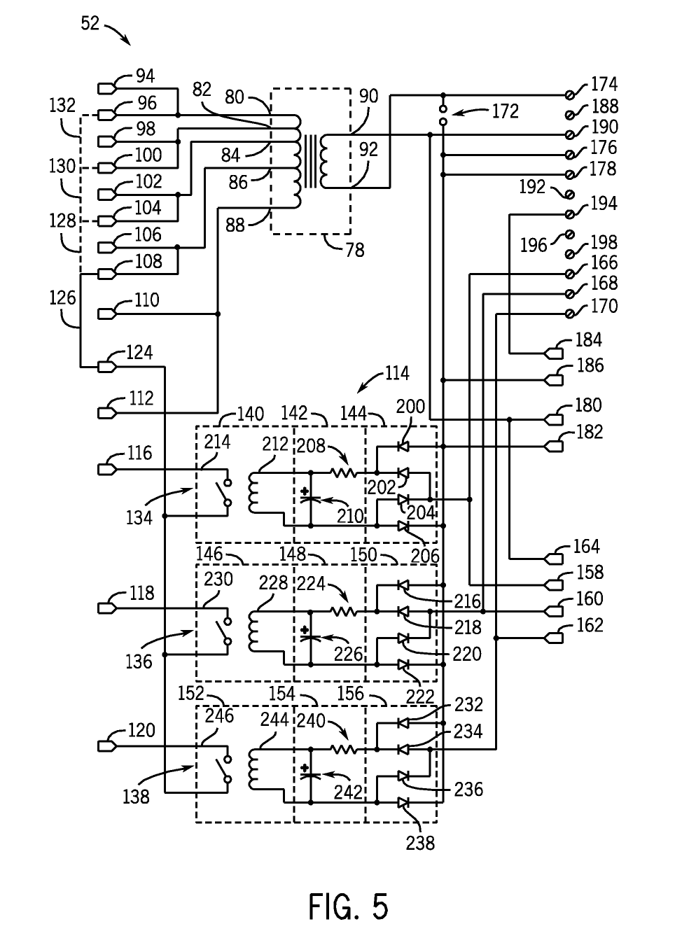

FIG. 5 is an electrical schematic of an exemplary configuration for fan relay board 52. Board 52 includes a transformer 78 with four taps 80, 82, 84, and 86 located at different connection points along a primary winding. Transformer 78 is configured to receive current through one on the taps 80, 82, 84, and 86 and allow the current to flow through the primary winding and exit though neutral, or ground connection point 88. Transformer 78 also includes a secondary winding designated by reference numerals 90 and 92 that is configured to produce an output current with a voltage of approximately 24 volts. Each tap 80, 82, 84, and 86 is electrically coupled to two connection terminals configured to receive line power. Two connection terminals are provided for each tap so that one terminal of each pair may be connected to the line power and the other terminal of each pair may be connected to the motor. Terminals 94 and 96 are configured to receive 277 volt line power and supply the power to tap 80. Terminals 98 and 100 are configured to receive 230 volt line power and supply the power to tap 82. Terminals 102 and 104 are configured to receive 208 volt line power and supply the power to tap 84. Terminals 106 and 108 are configured to receive 115 volt line power and supply the power to tap 86. Each of the taps 80, 82, 84, and 86 is connected at a point along the primary winding configured to convert the supply power into a 24 volt output on the second winding. According to exemplary embodiments, tap 80 may be connected to provide a winding ratio of 11.5 to 1 between the primary winding and the secondary winding, tap 82 may be connected to provide a winding ratio of 10 to 1, tap 84 may be connected to provide a winding ratio of 8.7 to 1, and tap 86 may be connected to provide a winding ratio of 5 to 1. Regardless of the terminal used to receive the line power, a neutral terminal 110 may be connected to the line power to complete the connection. Neutral terminal 110 is coupled to transformer 78 at connection point 88 and is coupled to a neutral terminal 112 for the fan motor. Although the terminals are generally shown as spade terminals, it should be noted that other types of terminals may be used such as clips, screw terminals, ring terminals, and the like.

The 24 volt output from the secondary winding of transformer 78 flows through fan relay board by means of conductive traces or elements (not shown) and is applied to a fan motor, such as motor 64 (shown in FIG. 4), by a distribution circuit 114. Distribution circuit 114 provides 24 volt power to three terminals 116, 118, and 120, each configured to power the fan motor at a different speed. Terminal 116 powers the motor at a high speed, terminal 118 powers the motor at a medium speed, and terminal power 120 powers the motor at a low speed. A terminal 124 provides power to the motor when connected to one of the line power terminals 94, 96, 98, 100, 102, 104, 106, and 108. A connector, such as a jumper 126 is configured to provide line power to the motor by electrically coupling one of the line power terminals to motor power terminal 124. As shown, the board 52 receives power from a 115 volt power supply, and jumper 126 connects terminals 108 and 124 to provide 115 volt power to the motor. The 115 volt power supply may be connected to board 52 at terminals 108 and 110. In applications that receive another voltage, the jumper may be configured differently to correspond to the line power received. For example, terminal 124 may be connected to terminal 104, as shown by jumper 128, when the line power is 208 volts. Terminal 124 may be connected to terminal 100, as shown by jumper 130, when the line power is 230 volts. Terminal 124 may be connected to terminal 96, as shown by jumper 132, when the line power is 277 volts. Although jumper connections are only shown for four of the eight terminals, it should be noted that the jumper may be connected to any of the line power terminals 94, 96, 98, 100, 104, 106, or 108 depending on the line power available.

Distribution circuit 114 includes three paths 134, 136, and 138 for applying the 24 volt output from transformer 78 to relays configured to operate the motor at a certain speed. Each path 134, 136, and 138 drives the motor at a high speed, medium speed, or low speed, respectively. Each path 134, 136, and 138 includes a relay, a filter, and a rectifier. Path 134, which drives the motor at a high speed, includes relay 140, filter 142, and rectifier 144. Path 136, which drives the motor at a medium speed, includes relay 146, filer 148, and rectifier 150. Path 138, which drives the motor at a low speed, includes relay 152, filter 154, and rectifier 156.

Each path 134, 136, and 138 is configured to convert the 24 volt output from the secondary winding and apply it to the relays. Rectifiers 144, 150, and 156 are configured to convert the 24 volt alternating current waveform into a 24 volt direct current waveform. The filters 142, 148, and 154 are configured to smooth the direct current waveform and provide a relatively constant current to relays 140, 146, and 152. Relays 140, 146, and 152 are configured to receive the current and energize a circuit to power the motor at the high, medium, or low speed.

The motor speed may be designated by an input applied to speed selection terminals 158, 160, and 162. The speed selection terminals may be configured to receive an input from a control device 22 (shown in FIG. 3). Speed selection terminal 158 is electrically coupled to path 134, which designated a high speed for the motor. Consequently, when the control device selects terminal 158, for example, by a switch or other suitable means, the motor operates at the high speed. Terminal 160 is electrically coupled to path 136, which drives the motor at a medium speed, and terminal 162 is electrically coupled to path 138, which drives the motor at a low speed. Therefore, the motor generally operates at a speed designated by speed selection terminal 158, 160, or 162. A control terminal 164 also may be coupled to the control device to provide and receive control signals from the control device, which for example, may function to turn the motor on and off.

Speed selection terminals 158, 160, and 162 also may be hard-wired to terminals 166, 168, and 170 to fix the motor speed. For example, terminal 158 may be connected by a jumper or other suitable means to terminal 166 to operate the motor at the high speed. The jumper allows the motor to run at the selected speed, in this case the high speed. Control terminal 164 may receive control signals from an input device to either turn the motor on at the high speed or turn the motor off. According to other embodiments, the speed may be selected as the medium speed by connecting terminal 160 to 168, or the speed may be designated as the low speed by connecting terminal 162 to 170. Thus, the position of the jumper, or connector, determines fan speed. The jumpers may be used to fix the motor speeds in applications where varying fan speeds are not desired. Although the terminals are shown in FIG. 5 as screw terminals, it should be noted that other terminal types may be used such as clips, tab terminals, tip terminals, and so forth.

Fan relay board 52 also may be electrically coupled to float switches, external devices, electrical heaters, and various valves and switches for controlling the heating and cooling. A jumper or shunt may be placed between terminals 172 to bypass a portion of the circuit that may be connected to a float switch. When a jumper is not located between terminals 172, terminal 174 and convenience terminals 176 and 178 may be connected to a float switch located within drain pan 58 (shown in FIG. 3). The float switch may include a float valve or other suitable arrangement that interrupts power to turn off the motor when the amount of condensate in the drain pan exceeds a designated level.

Fan relay board 52 may be configured to provide power to external devices through terminals 180 and 182. Terminals 180 and 182 may be electrically coupled to external devices, such as actuators or control valves, requiring 24 volt AC power. Fan relay board 52 also may be configured to apply power to an electric heater through terminals 184 and 186. The electric heater may include a resister that converts the 24 volt power into heat energy and provides additional heating capacity for the HVAC&R system.

Fan relay board 52 also may be configured to control various heating and cooling devices, switches, and valves using terminals 188, 190, 192, 194, 196, and 198. For example, an electrical trace or jumper may be provided between one of the convenience terminals 176 and 178 and terminal 188 to provide electrical communication with a switch, such as a float switch or a valve, such as a water control valve. In another example, terminal 184 may be disconnected from terminal 194 and connected instead to terminal 192, 196, or 198 to provide electrical communication between fan relay board 52 and a heating or cooling device. The electrical communication may be used to control mechanisms such as position control valves or modulating control valves that regulate the heating or cooling device. The control mechanisms may be part of the piping assembly provided with the air handler or the control mechanisms may be part of independent heating and cooling devices.

The 24 volt AC output provided by transformer 78 may be applied directly to the terminals that are couplable to external devices such as electric heat, actuators, and valves. However, before being applied to the motor control relays, the 24 volt AC waveform is converted to a 24 volt direct current (DC) waveform within distribution circuit 114. Each rectifier 144, 150, and 156 includes a set of four diodes for converting the alternating current waveform into a direct current waveform. Rectifier 144 includes diodes 200, 202, 204, and 206. Rectifier 150 includes diodes 216, 218, 220, and 222. Rectifier 156 includes diodes 232, 234, 236, and 238. Each set of four diodes is configured to function as a diode bridge, or bridge rectifier, that converts the input waveform into a waveform of constant polarity. A filter 142, 148, or 154 smoothes the direct current applied by rectifiers 144, 150, and 156. Each filter 142, 148, and 154 includes a resistor and a capacitor. Filter 142 includes resistor 208 and capacitor 210, filter 148 includes resistor 224 and capacitor 226, and filter 154 includes resistor 240 and capacitor 242. According to exemplary embodiments, each resistor may be a 300 ohm resistor and each capacitor may be a 330 capacitance capacitor. The current from each filter 142, 148, and 154 is applied respectively to relays 140, 146, and 152. Each relay includes a coil 212, 228, or 244 through which current flows when the appropriate path is selected. For example, when terminal 158 is selected by either a jumper to terminal 166 or by the speed selector input to terminal 158, path 134 receives current that flows through coil 212. The flow of current through coil 212 energizes switch 214 to drive the motor at the high speed. Within path 136, switch 230 is included in relay 146 and energized by coil 228 to drive the motor at the medium speed. Within path 138, switch 246 is included in relay 152 and energized by coil 244 to drive the motor at the low speed.

The fan relay boards described herein may find application in a wide variety of systems employing fans. However, the boards are particularly well-suited to fan coil units and variable air volume units used in HVAC&R systems receiving line power of approximately 115 volts, 208 volts, 230 volts, or 277 volts. The boards are intended to provide flexibility by working with a range of voltages and are intended to facilitate installation by including circuitry within a common board.

While only certain features and embodiments of the invention have been illustrated and described herein, many modifications and changes may occur to those skilled in the art (e.g., variations in sizes, structures, shapes and proportions of the various elements, values of parameters (e.g., voltages), mounting arrangements (e.g. circuit board components), use of materials, orientations, etc.) without materially departing from the novel teachings and advantages of the subject matter recited in the claims. For example, it should be noted that the voltages provided, 24 volts, 115 volts, 208 volts, 230 volts, and 277 volts are approximate root mean square voltages that may vary based on individual system properties, such as power supply fluctuations, flux leakage, and energy losses. Therefore, the voltages supplied are not intended to be limiting and are meant to cover a range of voltages. Specifically, 120 volts is intended to include voltages within a range of 100 volts to 130 volts, 208 volts is intended to include voltages within a range of 185 volts to 230 volts, 230 volts is intended to include voltages within a range of 200 volts to 265 volts, 277 volts is intended to include voltages within a range of 235 volts to 305 volts, and 24 volts is intended to include voltages within a range of 19 volts to 29 volts.

Moreover, the order or sequence of any process or method steps may be varied or re-sequenced according to alternative embodiments. It is, therefore, to be understood that the appended claims are intended to cover all such modifications and changes as fall within the true spirit of the invention. Furthermore, in an effort to provide a concise description of the exemplary embodiments, all features of an actual implementation may not have been described (i.e., those unrelated to the presently contemplated best mode of carrying out the invention, or those unrelated to enabling the claimed invention). It should be appreciated that in the development of any such actual implementation, as in any engineering or design project, numerous implementation specific decisions may be made. Such a development effort might be complex and time consuming, but would nevertheless be a routine undertaking of design, fabrication, and manufacture for those of ordinary skill having the benefit of this disclosure, without undue experimentation.

1. A heating, ventilating, air conditioning, or refrigeration fan power supply device comprising:
a transformer configured to convert an approximately 277 volt input to an approximately 24 volt output and to convert at least one of an approximately 230 volt input, an approximately 208 volt input, and an approximately 115 volt input to the approximately 24 volt output; and
a distribution circuit configured to receive the output and to provide power to a motor electrically coupled to one of the inputs.

2. The device of claim 1, wherein the inputs are single phase, alternating current inputs.

3. The device of claim 1, wherein the output is an alternating current waveform; and the distribution circuit includes a rectifier configured to rectify the output to a direct current waveform, and a relay energizeable by the direct current waveform to provide power to the motor.

4. The device of claim 3, comprising a plurality of relays configured to permit selection of a speed of the motor.

5. The device of claim 4, wherein the distribution circuit includes three relays, each relay configured to select a different speed for the motor.

6. The device of claim 3, comprising a filter configured to smooth the direct current waveform.

7. The device of claim 1, wherein the transformer is a multi-tap transformer capable of converting 277 volt, 230 volt, 208 volt, and 115 volt input power to 24 volt output power.

8. The device of claim 1, wherein the transformer and the distribution circuit are mounted on and interconnected with one another via a common circuit board.

9. The device of claim 8, comprising a terminal block mounted on the circuit board, the terminal block configured to electrically couple the output to at least one of a heating device, a cooling device, a valve, a damper, and a switch.

10. The device of claim 1, wherein the motor drives a centrifugal fan and the distribution circuit selects one of a high, a medium, and a low speed for the motor.

11. A multi-tap transformer for controlling a speed of a fan for a heating, ventilating, air conditioning, or refrigeration system, the transformer comprising:
a first tap configured to receive an approximately 277 volt power supply;
a second tap configured to receive an approximately 230 volt power supply;
a third tap configured to receive an approximately 208 volt power supply;
a fourth tap configured to receive an approximately 115 volt power supply; and
an output configured to provide an approximately 24 volt power supply to a distribution circuit that selects a designated speed for a fan motor powered by one of the 277 volt power supply, the 230 volt power supply, the 208 volt power supply, and the 115 volt power supply.

12. The transformer of claim 11, wherein the inputs are single phase, alternating current inputs.

13. The transformer of claim 12, wherein the 277 volt power supply is received from an approximately 277 volt building lighting circuit.

14. The transformer of claim 11, wherein the first tap is connected to a primary winding to provide a winding ratio of 11.5 to 1 between the primary winding and a secondary winding, the second tap is connected to the primary winding to provide a winding ratio of 10 to 1 between the primary winding and the secondary winding, the third tap is connected to the primary winding to provide a winding ratio of 8.7 to 1 between the primary winding and the secondary winding, and the fourth tap is connected to the primary winding to provide a winding ratio of 5 to 1 between the primary winding and the secondary winding.

15. The transformer of claim 11, wherein the transformer is mounted on a circuit board commonly with the distribution circuit.

16. The transformer of claim 15, wherein the circuit board includes two terminals configured to be coupled to one another by a jumper to designate the speed.

17. The transformer of claim 15, wherein the circuit board is electrically coupled to a control device configured to designate the speed.

18. The transformer of claim 15, wherein the circuit board is electrically coupled to a switch configured to designate the speed.

19. A ventilation system comprising:
a heat exchanger;
a fan configured to be driven by a motor and configured to direct air from the heat exchanger to an environment;
a circuit board configured to receive a control input and drive the motor at a speed designated by the control input;
a transformer mounted on the circuit board, the transformer configured to receive an approximately 277 volt power supply and at least one of an approximately 230 volt power supply, an approximately 208 volt power supply, and an approximately 115 volt power supply and provide an approximately 24 volt output; and
a distribution circuit including a plurality of relays configured to permit selection of the speed, the distribution circuit configured to receive the output.

20. The system of claim 19, comprising three relays, each relay configured to select a different speed for the motor.

21. The system of claim 19, comprising a thermostat configured to provide the control input.

22. A method for controlling a speed of a fan for a heating, ventilating, air conditioning, or refrigeration system, the method comprising:
coupling a board to an alternating current building power supply, the board being capable of receiving an approximately 115 volt single phase power supply, an approximately 208 volt single phase power supply, an approximately 230 volt single phase power supply, and an approximately 277 volt single phase power supply provided from an approximately 277 volt building lighting circuit;
coupling the board to a control input device configured to designate the speed from one of three different speeds; and
coupling the fan to three relays included on the board, each relay configured to select one of the three different speeds.
